(19) United States
(12) Patent Application Publication
(10) Pub. No.: US 2026/0073808 A1
(43) Pub. Date: Mar. 12, 2026

(54) SYSTEMS AND METHODS FOR VIRTUAL AUTONOMOUS VEHICLE DEMONSTRATION

(71) Applicant: Torc Robotics, Inc., Blacksburg, VA (US)

(72) Inventors: Carly Vickers, Christiansburg, VA (US); Zachary Ryan Joswick, Jacksonville, FL (US)

(21) Appl. No.: 18/882,470

(22) Filed: Sep. 11, 2024

(51) Int. Cl. G09B 9/05

(52) U.S. Cl. CPC G09B 9/05

(57) ABSTRACT

A virtual autonomous vehicle (VAV) demonstration system including a display device, a steering wheel, and a control device. The display device displays a VAV demonstration application which includes video data and steering wheel data obtained from a real-world driving session of an autonomous vehicle. A steering wheel moves in correspondence with the steering wheel data and a video generated using the video data. A computing device controls the steering wheel and outputs the video for display on the display device. The steering wheel is controlled based on to the steering wheel data and a video control scheme for controlling playback of the video, and the steering wheel data is synchronized with frames of the video such that the steering wheel is caused, by the steering wheel control scheme, to move in correspondence with motion of the autonomous vehicle in the video.

### TECHNICAL FIELD

The field of the disclosure relates generally to autonomous vehicles and, more specifically, to a virtual demonstration of an autonomous driving experience that conveys aspects of autonomous driving, to showcase and educate people on autonomous driving.

### BACKGROUND OF THE INVENTION

Autonomous driving via autonomous vehicles refers to the capability of vehicles to operate without human intervention at least in some levels and for at least some functions. These autonomous vehicles rely on sensor technology to navigate roads, interpret traffic conditions, traffic signs, and avoid obstacles. The general public is still largely unaccustomed to the driving experience of autonomous vehicles, including aspects such as: (1) sensors used by autonomous vehicles, such as lidar (light detection and ranging), radar, and cameras; (2) perception by the autonomous vehicle, for example to identify lane markings, traffic signs, pedestrians, and other vehicles; (3) localization and mapping performed by the autonomous vehicle; and (4) path planning and control by the autonomous vehicle. It is difficult for human drivers to understand the perspective of video demonstrations that show autonomous vehicles driving without the look and feel of a vehicle setting, such as being seated in a driver's seat behind a steering wheel, and being able to see what is shown both through the windshield and in various rear view mirrors (e.g., left and right rear view mirrors). Accordingly, there is need for a simulation conveys the look and feel of autonomous driving and aspects of what a ride-along human driver would experience, without needing to bring an actual autonomous vehicle to trade and industry shows.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, the disclosed virtual autonomous vehicle (VAV) demonstration system includes: a display device configured to display a VAV demonstration application that includes video data and steering wheel data obtained from a real-world driving session of an autonomous vehicle; a steering wheel; and a control device coupled with the steering wheel and the display device. The control device includes at least one processor in communication with at least one memory device, the at least one processor programmed to: control, via a video control scheme, playback of the video data; and control, via a steering wheel control scheme, movement of the steering wheel (i) based on the steering wheel data and (ii) in correspondence with motion of the autonomous vehicle in the video data.

In another aspect, the disclosed method for a virtual autonomous vehicle (VAV) demonstration includes: configuring a display device to display a VAV demonstration application, the VAV demonstration application includes video data and steering wheel data obtained from a real-world driving session of an autonomous vehicle; providing a steering wheel; coupling a control device with the steering wheel and the display device; controlling, via a video control scheme, playback of the video data; and controlling, via a steering wheel control scheme, movement of the steering wheel (i) based on the steering wheel data and (ii) in correspondence with motion of the autonomous vehicle in the video data.

In yet another aspect, the disclosed one or more non-transitory computer-readable storage media for a virtual autonomous vehicle (VAV) demonstration includes a plurality of instructions stored thereon that, in response to being executed, cause a VAV demonstration system to: display a VAV demonstration application on a display device of the VAV demonstration system, wherein the VAV demonstration application includes video data and steering wheel data obtained from a real-world driving session of an autonomous vehicle; control, via a video control scheme, playback of the video data; and control, via a steering wheel control scheme, movement of the steering wheel (i) based on the steering wheel data and (ii) in correspondence with motion of the autonomous vehicle in the video data.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle according to one embodiment of the present disclosure;

FIG. 2 is a block diagram of an autonomous vehicle according to one embodiment of the present disclosure;

FIG. 3 is a schematic diagram of an example virtual autonomous vehicle demonstration setup according to one embodiment of the present disclosure;

FIG. 4A illustrates an embodiment of an example graphical user interface of a demonstration software application according to one embodiment of the present disclosure;

FIG. 4B illustrates example scenario symbols of the graphical user interface of the demonstration software application of FIG. 4A, according to one embodiment of the present disclosure;

FIGS. 5A to 5F illustrate example sequential interface screens of an example demonstration experience by a user according to one embodiment of the present disclosure;

FIGS. 6A to 6H illustrate an example embodiment of a screen transition sequence and transition effect(s) utilized as part of video playback aspects within the demonstration application according to one embodiment of the present disclosure;

FIG. 7 illustrates an example flow chart of a main control program according to one embodiment of the present disclosure;

FIG. 8 illustrates an example flow chart of a wheel control program according to one embodiment of the present disclosure;

FIG. 9 illustrates an example flow chart of status light control program according to one embodiment of the present disclosure;

FIG. 10 illustrates an example method of creating and exhibiting the demonstration application according to one embodiment of the present disclosure;

FIG. 11 is a block diagram showing an example configuration of a computing device according to one embodiment of the present disclosure; and

FIG. 12 is a block diagram showing an example configuration of an autonomy computing device according to one embodiment of the present disclosure.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

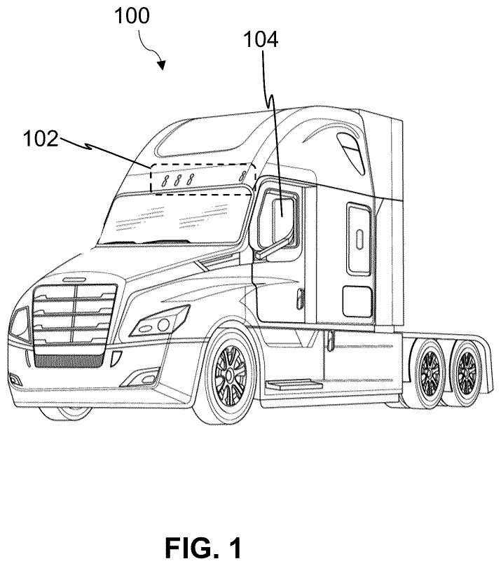

The virtual autonomous vehicle demonstration (also referred to herein as “demo”) disclosed herein utilizes a demo software application (also referred to a “demo application”) and a demo system including, for example, a video display with a steering wheel, where the display and wheel are utilized in conjunction with (i) actual video recorded by autonomous vehicles from driving sessions, and (ii) the corresponding vehicle data sensed by sensors and other instrumentation of the autonomous vehicle during such driving sessions, which may include environmental data and wheel movement data, for example. Thus, real-world video and real-world vehicle data are utilized in conjunction with the video display and wheel to effectively re-perform a real-world driving session of an autonomous vehicle through the connected wheel to give participants in the demo a first-hand perspective of autonomous driving, thereby increasing knowledge and interaction with the technology. The real-world data may be grouped into certain driving scenarios, to represent how the autonomous vehicle performed during such driving scenarios in the real world. The driving scenarios (also referred to as just “scenarios”) may include, but are not limited to, highway driving, lane changes, highway merging, and intersections. Thus, the scenarios of the demo may include real-world data from one or more autonomous vehicles that had one or more driving sessions including highway driving, lane changes, highway merging, and/or intersections. The demo described herein may be used at trade shows and other industry shows to drive engagement and education, without having to bring an actual autonomous vehicle (e.g., cab/tractor of an autonomous vehicle 100 shown in FIG. 1, described later) to the show(s)/event(s). This reduces costs and streamlines booth displays by trade show participants (e.g., auto-makers) attending and presenting at such shows, while gaining public trust with autonomous vehicles from the general public and other trade show attendees. For example, for marketing and/or other data collection purposes, various interactive surveys such as “before” and “after” surveys may be presented to demo participants to gauge their responses. Such surveys may be presented as part of the demo before the main driving demonstration begins, and after the participant finishes interacting with the demo. Responses to the survey may be entered by participants via a controller such as a remote control, touch screen interface associated with the demo, and/or control buttons located on the wheel. Alternatively, or additionally, a separate survey kiosk may be utilized. Responses may be recorded and stored by the entity operating the demo to build a database of user sentiment towards autonomous driving and other aspects related thereto.

The real-world vehicle data may be obtained from the various sensors and other sensing features of the autonomous vehicle. Alternatively, simulated data of the same file type as the real-world data may be used, and the wheel accessory may be mapped to the simulated data. This data may, for example, be used in conjunction with the Robot Operating System (ROS), which is a flexible and powerful platform used for building robotic systems software components. ROS bag files (e.g., bag files, or Rosbags) are a file format used in ROS to store message data, and are a main way to log data in ROS, and often used to record data from sensors, actuators, and algorithms during a robot run. Using ROS is described only for example and for illustration purposes only. Other similar platforms/operating systems may be utilized, and usage of the ROS is not limiting.

More specifically, the demo includes a wheel and video playback system which includes a novel video player and custom wheel position controller for simultaneous playback of autonomous vehicle camera data alongside time synchronized steering wheel data of the autonomous vehicle. The playback system displays a video to the user and simultaneously commands a steering wheel accessory (e.g., a commercially available steering wheel accessory) to mimic the movements of the autonomous vehicle (e.g., an autonomous vehicle (e.g., tractor) as shown in FIG. 1) in the manner shown in the video, providing a visual representation of acts that an autonomous (e.g., virtual) driver is performing, which is often lost when reviewing videos of such in isolation. A custom position controller for the wheel is configured to move the wheel to the angle output from the autonomous vehicle driving data using the existing software/hardware interface included with the steering wheel accessory. The position controller described herein matches the wheel's movement directly to the frames in the video and interpolates the movement between frames to provide relatively smooth playback.

Commercially available steering wheel accessories such as consumer racing wheels are designed for simulating force feedback during racing games. As a result, the standard interface for controlling these wheels involves sending forces for a specified duration over a link (e.g., USB link). A force has a strength parameter (also referred to as a level parameter) that controls the intensity of the movement, as well as a duration parameter (also referred to as attack_length) which defines how long the force should be applied. There are many other parameters that can be set for the forces that allow fading out or other effects. The position of the wheel can be read out at any point via the same USB link/connection.

In a conventional computer or video game system steering wheel accessory, such as those used as a controller for playing a video game such as a car racing game or simulation, when a user turns the wheel, sensors within the wheel detect the angle and speed of the turn, and the game's software calculates the resulting forces based on the car's speed, the type of turn, and the road surface. Force feedback motors within the wheel then apply the appropriate torque and vibrations to the wheel, simulating the physical sensations of driving. The forces applied to the wheel are represented as vectors, simulating the forces a user would feel due to acceleration, braking, and turning. Rotational force (e.g., torque) is applied to the wheel, where the force feedback system adjusts the torque to simulate the resistance a user would feel when turning the wheel. The system can simulate different types of vibrations and resistance. For example, driving over rough terrain or hitting a curb may produce specific vibrations and resistance patterns. The software uses control algorithms to calculate the forces that need to be applied to the wheel. These algorithms consider various factors such as the vehicle's speed, the type of surface, and the forces acting on the car.

In such a conventional racing video game that is capable of being used with a steering wheel accessory, forces need to be applied to the wheel irrespective of the current angle of the wheel, such as when simulating a bump in the road (e.g., the force of the bump will be applied no matter if the player is turning in a corner or driving in a straight line). Then the wheel angle is read so the game engine can set the angle of the wheels in the game. This mechanism works for simulation of driving feedback to a user when the user is acting as the input to the system.

However, for the demo experience and its demo application described herein, there is a need to actively drive the wheel to a desired angle without a user holding it or applying force, rather than applying simulated forces to the wheel. This by default is not possible via the standard control software of the steering wheel accessory, necessitating development of a custom control loop and custom position controller as described herein to be able to actively drive the wheel to a desired angle.

The control loop may run on a fixed duration time clock generated by a library (e.g., GUI library). This clock is also responsible for driving a core graphical loop as well as animations which ensures that both device output and the user interface (UI) remain in sync through the execution of the program. The demo application's purpose is to move the wheel in sync with a replayed wheel movement in correspondence with actual driving data from a real-world autonomous vehicle. The wheel data from the real-world autonomous vehicle is recorded in a certain file format such as ROS bag file. This bag file is sized such that it matches the length, duration, and rate of the video file that is also played. The steering data may be stored as a floating-point value and has a timestamp for each message in the bag. When the demo application loads a video/bag combination, the bag file is parsed and the angle values read and saved into an in-memory map data structure with the key being the time represented as an integer time unit (e.g., nanoseconds), and the value set to the angle value for the message at that time.

In the execution of the control loop, the current progress into the video is read and the timestamp of the video frame is calculated. Then a search through the map for the closest timestamp to the video frame timestamp is performed and the angle value for that time is retrieved. This angle value is then set as a target angle for the wheel, and a calculation is performed to determine what force if any should be sent to the wheel for this iteration of the control loop. The wheel force control may be performed in two phases depending on how far the current actual angle is from the target angle. If the difference between the current angle value and the target angle is a small value under a configurable threshold, a braking routine is used to calculate the torque value. This braking torque value uses a calculation to determine the correct direction and force to apply to keep the wheel centered at its current point. This torque value may be set proportionally to the difference to smoothly stop the wheel at a desired location without introducing oscillations that break the immersion of the user. This braking torque value acts to smoothly stop the wheel at the desired position, but also works to counteract a force applied by the viewer if they are resting their hands on the wheel during the demo. The torque value used can be up to a maximum safe torque limit, but within the small range of braking position, so that the user can still force the wheel to a different angle if they desire, which engages a rotation calculation routine. If the target position is achieved within a tolerance, the commanded torque is set to 0 to hold the wheel in place.

If the target position is outside of the small braking torque tolerance, a switch is made to using the rotation calculation routine, which may be configured to operate in various modes, such as low speed and/or high-speed torque modes depending on the magnitude of the difference between the current and target positions. If the magnitude is under a configurable high-speed threshold, a low-speed torque value may be used which is set to move the wheel at a mild safe pace towards the braking region. The routine applies the constant low speed torque value to the wheel for the current cycle. This smooths the transition from the rotation route to the braking routine and acts to decelerate the wheel from the high-speed torque. If the wheel position is greater than the high-speed threshold, the high-speed torque value may be used to quickly drive the wheel towards the desired position. Together, the torque control drives the wheel quickly to any desired position from any starting position but does not overshoot and instead stops precisely and smoothly at the target position. Additionally, if the user places their hands on the wheel it will have enough torque to continue smooth operation and following of the actual real-world wheel data (e.g., the bag recorded wheel). Furthermore, if the user decides to try and force the wheel to a different position, the wheel may initially start with a smaller corrective force, and as the magnitude of the difference increases past the high speed threshold, the force may increase up to the safe limit set by the software (which may not be configurable at runtime).

The use of a physical moving wheel as part of a demo experience as described herein is more visually distinct from a flat video display screen typically seen at trade show booths, and the interactive elements motivate individuals to stay at the booth longer and be more engaged with the content. The demo application may be configured via an input configuration file (e.g., input Json “config” file) which defines which video and files (e.g., bag files) will be played. Making the demo application “config” driven enables rapid creation and editing of configurations, as well has providing for individual configurations that target specific trade events (for example, a fire/police trade show could have a “config” including scenario videos that show the autonomous vehicle's response to emergency vehicles passing by on a road/highway).

The demo may also utilize a controllable status light to indicate an operating state of the vehicle to a user. During operation of the actual autonomous vehicle, the vehicle records if it is being driven manually or autonomously. To convey this to a user of the demo, the status light may be illuminated in a configurable color when the vehicle is operating autonomously and may change color or turn off when the vehicle is in the manual state. The status light serves as a visual element that can attract viewers'attention and makes it clear which operating mode the vehicle is in.

The demo application interfaces with the status light to indicate to a user the (e.g., autonomous or manual) status of the vehicle. For example, a green color illumination may indicate that the vehicle is in an autonomous driving mode, whereas a red color illumination (or no illumination) may indicate a manual (or idle state) of the vehicle. The control of the status light is optional and can be enabled or disabled at runtime depending on if the light is available at the trade show and/or desired for any given event. Control of the status light is accomplished through a custom status light control scheme that controls the interactions over the USB interface. The status light may have a documented software interface by which colors and patterns can be set, which may be limited to single static colors, or patterns of colors blinking. In order to achieve light patterns for fading or smoothly transitioning between colors (e.g., have the light fade on/off smoothly rather than abruptly turning on and off), the custom control scheme (e.g., a light controller) may be utilized to provide a range of light effects that can be applied to the status light with various parameters. These effects may be implemented in an event loop run in a separate thread by the UI framework, so that the status light remains synchronized with the other aspects of the demo, but is not impacted by the processing performed in other parts of the system. A main event loop may run the correct effect function responsible for implementing the effect logic. Each of the effects may use variables shared across iterations to compute the color/brightness that is necessary to implement the desired effect. Some effects implemented include but are not limited to fading in/out, a flashing pattern, a smooth multicolor transition, a solid color, and an off state. There may also be a mandatory “keep alive” signal required to keep the light on, which if not sent within a periodic time frame (e.g., every 30 seconds) will cause the light to turn off. A “keep alive” loop may be started/stopped whenever needed based on the currently applied effect and sends the “keep alive” message periodically to ensure the status light remains in its current state. These effects are intended to be set by various events in the main control loop of the demo application and then run without feedback in the background via an asynchronous signaling mechanism. Decoupling the light controller makes the demo program more modular and allows the status light to be enabled and disabled entirely in a straightforward manner. The main control loop of the demo application then uses the aforementioned control scheme to display the state of the vehicle (if the vehicle is being driven by the autonomous software or is being manually driven by a safety driver) in sync with the video and wheel movements previously described. In a similar manner to how the steering angle data is loaded, the autonomous status of the vehicle may be loaded out of the file (e.g., ROS bag) and indexed based on a timestamp, where in the main control loop of the demo application, the same video timestamp used for steering angle calculation is used to search for the appropriate autonomous state value. This value is then used to determine if the status light should be illuminated or not, which signals if the vehicle is operating in autonomous or manual mode at that time in the video. The demo application may display a solid configurable color when in autonomous mode and may turn completely off when in manual mode. Between these two states a smooth fade is performed which makes the state transition less jarring for the user/viewer. The light may also fade to an off state when transitioning between any two videos and may only turn back on after the transition has completed and/or if the new video is in an autonomous state. The default state of off may also be used in situations where no autonomous state data is available.

In operation, the demo application starts in an idle state playing back a video in the background (and moving the wheel) while a series of on-screen button icons are displayed to the user. These buttons are associated with a particular driving scenario, and when selected load into the corresponding scenario video, which may be a separate video and file (e.g., bag file) which highlights a specific behavior or action the vehicle is taking. The scenario may be shorter duration than the idle video. When transitioning between the main (e.g., idle) video and the scenario video, a transition effect/animation/video may be played. The transition effect/animation/video may utilize a logo or other associated branding as an overlay graphic to temporarily hide the underlying video, stitch it out, then show it again. This is accomplished by playing a forward transition video, pausing on the last frame (a separate image file), then swapping to a reversed version of the transition video which may be configured as a separate file. When played correctly in order, the user experiences a seamless transition between the two videos. This transition effect works on any two videos and is rendered in real-time as an overlay. The transition may include a wipe transition (e.g., circle wipe transition effect), a fade in/fade out transition, left-to-right transition, right-to-left transition, and the like.

The use of a steering wheel accessory as an output device for autonomous vehicle data, when integrated with the video player and adding the interactive elements for use in trade show/marketing events is a novel implementation of such components. The tight integration of these components together allows the creation of a seamless presentation fit for display to a general audience, and the use of the wheel to display the motion of the autonomous vehicle for the purpose of attracting attendees at trade shows provides a unique and novel experience to users (e.g., attendees of the trade show/event). Making the demo application fully configurable dramatically increases the versatility and reusability of the system for different events and different scenarios and lowers the barrier to making changes such that software development experience is not required to modify the configuration.

Furthermore, the integration of the status light adds another visual element to the experience and conveys to the user in a very direct way when the system is operating in autonomous mode to clearly communicate to the users the (e.g., autonomous) status of the vehicle. This integration also represents a novel combination of components, utilizing commercially available USB-based peripherals in a unique manner. The status light provides flexibility to control the exact desired color of light and perform effects that would not be possible with other lighting solutions such as a fixed color stack light.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present patent application and the scope of the appended claims.

FIG. 1 is a schematic diagram of an autonomous vehicle 100, which includes an array 102 of sensors, and a (e.g., left) sideview mirror 104 (and a corresponding right sideview mirror (not shown)), each of which may include its own sensor (e.g., camera) therein.

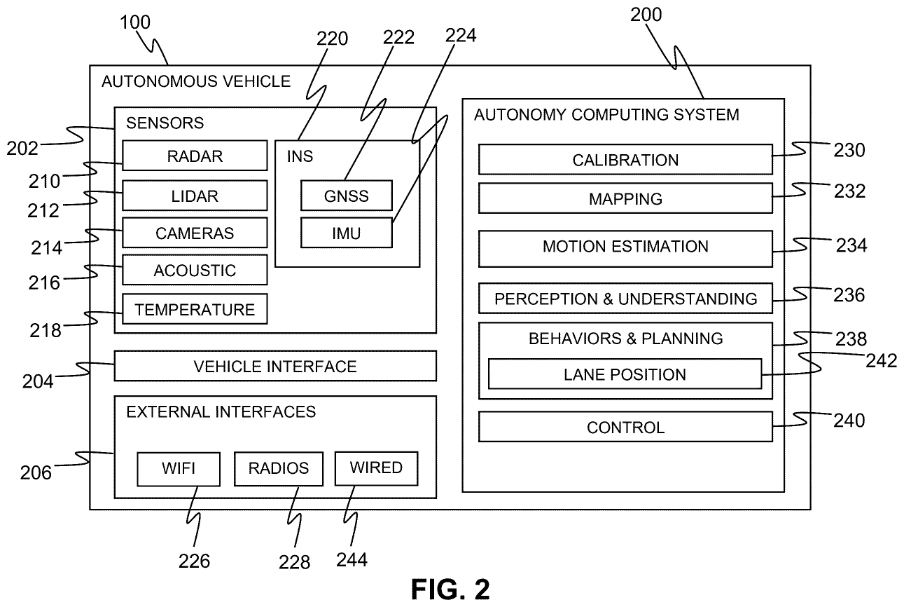

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206 (shown in FIG. 2). The sensors of array 102 may include 202, such as cameras, LiDAR, etc.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operation of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras'FOVs, which may be used to, for example, generate a bird's eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. Radar sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and lane position module 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Lane position module 242 maintains proper lane position for autonomous vehicle 100 in all conditions, e.g., regardless of signage for given road conditions. Lane position module 242 receives, for example, positions of left or right lane markings from perception and understanding module 236 and computes a lane position offset from the identified lane marking. Where both left and right lane markings are detected by perceptions and understanding module 236, in combination with sensors 202, lane position module 242 selects one lane marking from which lane positioning is derived.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

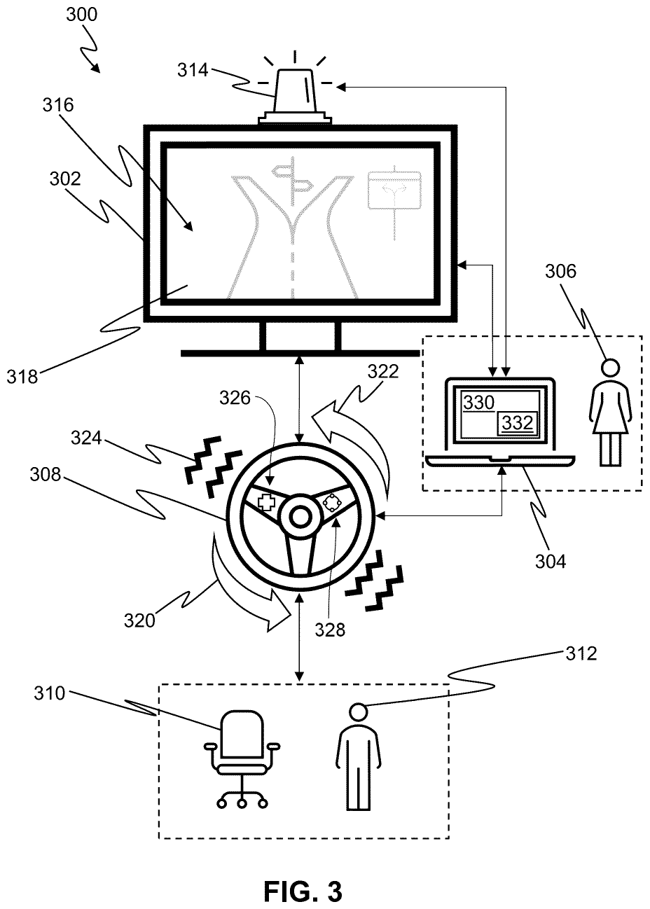

FIG. 3 is a schematic diagram of an example virtual autonomous vehicle (VAV) demonstration system 300. VAV demonstration system 300 includes a display device 302, a control device 304 for operation by an operator 306, and a steering wheel 308 (also referred to as a wheel device). VAV demonstration system 300 may further include a seat 310, such as a chair, for a user 312 to sit in during a demo session. In some embodiments, seat 310 may be a gaming chair, or a chair configured to simulate driving in a vehicle, such as a racing simulator cockpit chair or other simulation racing seat. VAV demonstration system 300 may further include a status light 314. User 312 may be a trade show or other event attendee, for example.

Display device 302 may be a monitor or television or other display capable of interfacing with control device 304 for display of demo application video 316 on screen 318 of display device 302, and may include various inputs/outputs such as HDMI ports, speakers for audio, and the like.

Control device 304 may be a computer, in particular a portable computer such as a laptop or other computing device such as a tablet. A portable computer may be used to simplify transport of control device 304 to and from a trade show/event as part of installing and operating the demo experience at the trade show/event. Control device 304 may include one or more storage devices including local storage such as a hard drive and/or other removable media such as a removable USB storage drive for storing the files of demo application video 316 for execution and playback of demo application video 316, or have access via a network (e.g., the internet) to remote (e.g., cloud) storage for storage and retrieval of the files of demo application video 316. Because trade shows and events commonly do not have stable internet connections available, local storage on control device 304 may be used for the storage of demo application video 316 to reduce reliance on having a suitable network connection, and so that control device 304 with the files for demo application video 316 stored locally thereon can run independently without a need for an internet connection. Control device 304 may include various inputs/outputs such as HDMI ports for outputting video to devices such as display device 302 (e.g., to mirror or output the display content of control device 304 to display device 302), USB ports for the connection of peripherals such as removable USB storage, wheel device 308, status light 314, a keyboard (not shown), and the like. For example, the keyboard may be an external keyboard connected (e.g., via USB, or wirelessly such as via Bluetooth) to control device 304 and may be part of the installation for VAV demonstration system 300. Operator 306 may be an employee of the company that is providing/displaying the demo experience, or some other entity such as a trade show host running the demo experience.

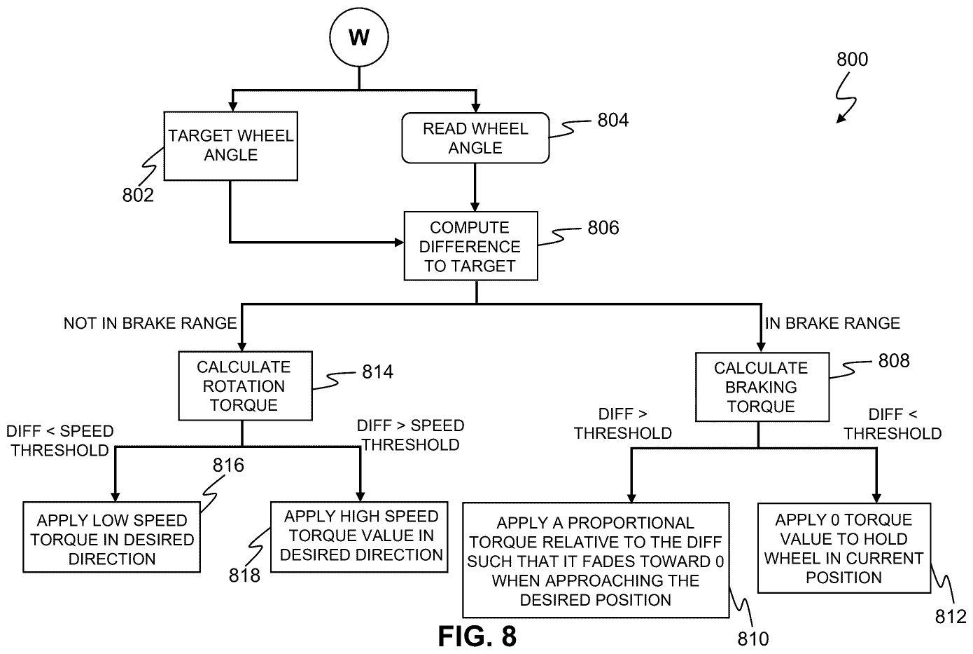

Wheel device 308, as described above, may be a commercially available wheel accessory used to play video games or other similar computer simulations (e.g., a computer-based steering wheel), namely video games and simulations that focus on driving/racing vehicles. Control of wheel device 308 may be augmented by custom code and algorithms (shown in FIG. 8) that manipulates certain aspects of control of wheel device 308. In particular, wheel device 308 may be programmed to generate movement of the wheel that corresponds to real-world wheel data and real-world video as described above. Wheel device 308 is programmed to be mapped to actual vehicle data so that the wheel moves in the same manner as did the autonomous vehicle (e.g., autonomous vehicle 100 shown in FIG. 1) from which the driving data was obtained, and the corresponding video is synchronized with the wheel movement to provide a re-creation of an actual driving session of an autonomous vehicle. More specifically, torque and force feedback aspects of wheel device 308 are used in the demo and are controlled to move wheel device 308 in the same manner that the wheel of the autonomous vehicle moved in real-life during a driving session, the wheel movement being synchronized to the corresponding video recorded by the autonomous vehicle during the driving session as described above, to convey autonomous driving from the perspective of a ride-along human driver that rides in the cab of autonomous vehicle 100. As described herein, wheel device 308, when controlled by the corresponding files of the demo application video 316, will move in directions 320 and 322 in accordance with the on-screen movement of the vehicle in the video of any given scenario, and may also generate haptic feedback 324 to add a sense of realism to the demo experience (where such haptic feedback 324 may reflect data captured by the autonomous vehicle 100 during a real-world driving session). Wheel device 308 may also include controls such as a directional pad 326 and one or more control buttons 328 used, for example, for selection of different scenarios available within demo application video 316, as described herein. Control device 304 has stored thereon demo application 330 and demo application files 332, which are executed/run on control device 304. The corresponding controls programmed in demo application files 332 are output from the demo application 330 to cause display device 302 to visually display the demo application video 316 and to cause wheel device 308 to be controlled. Wheel device 308 is controlled to both serve as a control to select scenario options and/or other selectable options of the demo application video 316 and to match the on-screen movement shown in the various scenarios of the demo application video 316.

The real-world vehicle data used as part of demo application video 316 may be data obtained from sensors 202 shown in FIG. 2. For example, the video(s) used in a scenario of demo application video 316 may be video obtained by cameras 214, including side or rear-view cameras, front or rear-facing cameras, and the like. Computer vision (e.g., lidar) videos may be used as part of the scenarios in demo application video 316 and may use data obtained from LiDAR 212. Wheel data used as part of scenarios of demo application video 316 may be sourced from data associated with vehicle interface 204 which is used to send commands to the various aspects of autonomous vehicle 100 such as the steering wheel.

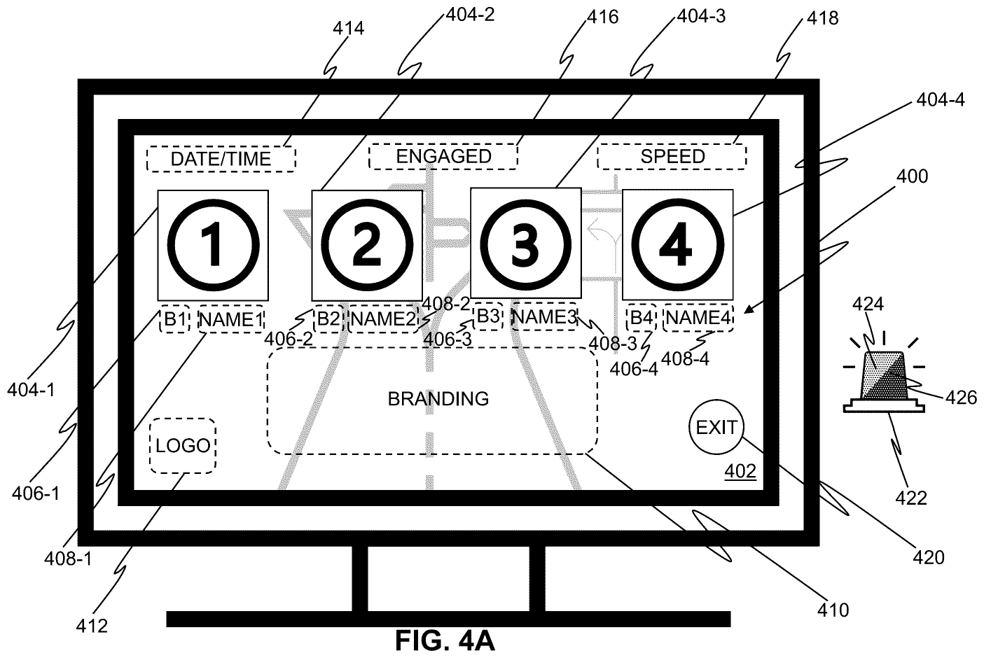

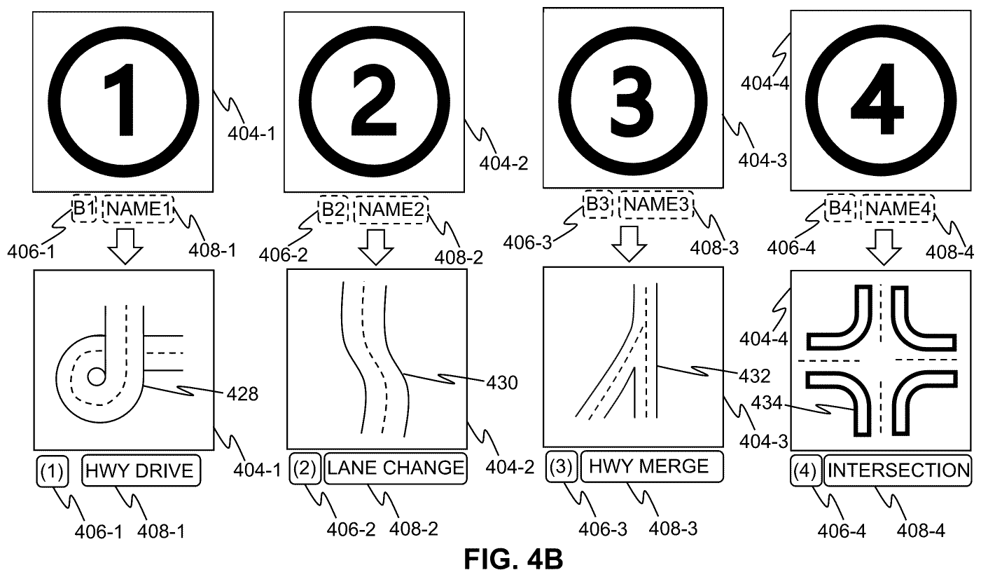

FIG. 4A illustrates an embodiment of a graphical user interface (UI) of the demo application (e.g., 330) as displayed, for example, on a display device such as display device 302 (each shown in FIG. 3). UI 400 depicts, for example, an idle state of the demo application. The idle state may show a stock video 402 (the same as or similar to demo application 316 shown in FIG. 3) or rotations of stock videos that play in the background while being overlaid with a plurality of icons and/or other information and graphics, some of which are interactive (e.g., selectable by a user such as user 312 shown in FIG. 3 as part of the demo experience). Stock video 402 may include, for example, a video showing the autonomous vehicle driving on a road or highway, using a (e.g., front-facing) video recorded by one or more autonomous vehicles during real-world driving sessions of the autonomous vehicle(s). The idle state may be a state of the demo application that is displayed during inactive periods when the demo is not being actively used by a user, and UI 400 may also be referred to as a start/introduction screen since it will normally be the first screen that a user sees/interacts with upon interacting with the demo. Additionally, the demo application may be programmed to return to the start screen after a certain duration of non-usage, such as 10 seconds. In the idle state, the steering wheel (e.g., 308) may be programmed to be constantly moving (e.g., steering) to simulate the movement of the autonomous vehicle driving on a highway (e.g., switching lanes, etc.). The moving steering wheel may generate interest in attendees/guests passing by a demo booth installed at a trade show that showcases the demo

UI 400 may include an arrangement of selectable icons corresponding to a driving scenario, such as scenario icon 404-1 (e.g., scenario 1), scenario icon 404-2 (e.g., scenario 2), scenario icon 404-3 (e.g., scenario 3), and scenario icon 404-4 (e.g., scenario 4). Selection of an icon 404-1 to 404-4 via the buttons (e.g., 328) on the wheel device (e.g., 308) cause the corresponding scenario to launch, which includes loading of the corresponding video data, wheel data, and/or status light data located within the associated scenario files (e.g., part of demo application files 332). There may also be more (or less) than four icons, and the arrangement of the icons may differ from that shown in FIG. 4A. For example, the icons may be arranged in alternating fashion, such as a checkerboard pattern, and the spacing between icons may be set at a variety of consistent or varying intervals. The icons may also be used to indicate and actuate the opening/loading of items besides scenarios, such as links to partners, surveys, and other pertinent or related information (e.g., diagnostics). Adjacent (e.g., below) each scenario icon 404-1 to 404-4 may be a button icon indicating which button (e.g., buttons 328 of wheel device 308, each shown in FIG. 3) to press for selection of the corresponding icon/scenario. For example, buttons 328 of wheel device 308 may include four or more buttons each labeled with a different symbol, letter, or number, and the button icons may show a matching symbol, so that a user knows that pressing a certain button 328 will trigger a certain scenario. In some embodiments, one single button 328 is used and a specific button icon 406-1 to 406-4 is selected by cycling through button icons 406-1 to 406-4. In other embodiments, a button icon 406-1 to 406-4 may be selected by turning steering wheel 308. Button icon 406-1 (e.g., B1), 406-2 (e.g., B2), 406-3 (e.g., B3), and 406-4 (e.g., B4) are adjacent (e.g., below) each corresponding scenario icon 404-1 to 404-4 (e.g., button icon 406-1 (B1) is below first scenario icon 404-1, button icon 406-2 (B2) is below second scenario icon 404-2, button icon 406-3 (B3) is below third scenario icon 404-3, and button icon 406-4 (B4) is below fourth scenario icon 404-4. There may also be a name icon 408-1 to 408-4 listing the name of the scenario for each corresponding icon 404-1 to 404-4. Name icons 408-1 (e.g., NAME1), 408-2 (e.g., NAME2), 408-3 (e.g., NAME3), and 408-4 (e.g., NAME4) are adjacent (e.g., below) each corresponding scenario icon 404-1 to 404-4 and adjacent each corresponding button icon 406-1 to 406-4 (e.g., name icon 408-1 (NAME1) is below first scenario icon 404-1 and adjacent button icon 406-1 (B1), name icon 408-2 (NAME2) is below second scenario icon 404-2 and adjacent button icon 406-2 (B2), name icon 408-3 (NAME3) is below third scenario icon 404-3 and adjacent button icon 406-3 (B3), and name icon 408-4 (NAME4) is below fourth scenario icon 404-4 and adjacent button icon 406-4 (B4). Name icons 408-1 to 408-4 may be labeled with a name corresponding to the driving scenario, such as HWY DRIVE for the first scenario, LANE CHANGE for the second scenario, HWY MERGE for the third scenario, INTERSECTION for the fourth scenario, and the like, the names giving a brief description of the scenario to assist a user in selecting the desired scenario. These are merely example naming schemes for scenario types and are not limiting. For example, in the emergency vehicle context, there may be a scenario named PASSING EMER for a passing emergency vehicle. In one example, selection of scenarios may be accomplished by selecting a scenario icon 404-1 to 404-4 or name icon 408-1 to 408-4 using the mechanism as described above with respect to button icons 406-1 to 406-4.

UI 400 may also include various branding graphics 410 and 412 that provide for the display of company names, logos, slogans, and the like. UI 400 may further include information such as date/time 414, and scenario status indicators relating to informational aspects of the scenarios, such as a driving state indicator 416 indicating a driving state of the automobile (e.g., autonomous driving is engaged), and speed indicator 418 of the autonomous vehicle in the scenario. Date/time 414 may be the current date/time or the date/time of the driving session from which the video of the scenario was captured. UI 400 may also include an EXIT button 420 to exit out of any particular screen, session, etc. A status light 422 (e.g., the same as or similar to status light 314 shown in FIG. 3) may be positioned adjacent the display device that is displaying UI 400 to provide a visual cue to the user as to which state the vehicle is in, for example an autonomous driving mode or a manual driving mode, where a color 424 may be representative of the autonomous driving mode, and color 426 may be representative of a manual driving mode (e.g., green illumination may be used for color 424 for indicating autonomous driving mode, and red illumination (or no illumination) for color 426 may be used for indicating manual driving mode). For example, since both status light 422 and driving state indicator 416 are mapped to indicate the driving state of the autonomous vehicle in any given scenario, status light 422 would illuminate in color 424 when driving state indicator 416 indicates that autonomous driving is engaged (and vice versa), and status light 422 would illuminate in color 426 when driving state indicator 416 indicates that manual driving mode of the autonomous vehicle is engaged.

FIG. 4B illustrates scenario symbols 428, 430, 432, and 434 that may be used as the symbols for scenario icons 404-1 (first scenario), 404-2 (second scenario), 404-3 (third scenario), and 404-4 (fourth scenario). Scenario symbols 428, 430, 434, and 434 may depict different graphical representations of driving and/or sections of road/highway. For example, scenario symbol 428 corresponding to the first scenario illustrates a section of highway indicating a highway driving scenario. Button icon 406-1 for the first scenario may include a “1” symbol or other symbol matching a symbol on the corresponding button of the buttons (e.g., 328) of the wheel device (e.g., 308, each shown in FIG. 3). Name icon 408-1 for the first scenario may indicate a (e.g., abbreviated) name such as “HWY DRIVE.” Scenario symbol 430 corresponding to the second scenario illustrates a lane of a road/highway indicating a lane change scenario. Button icon 406-2 for the second scenario may include a “2” symbol or other symbol matching a symbol on the corresponding button of the buttons (e.g., 328) of the wheel device (e.g., 308, each shown in FIG. 3). Name icon 408-2 for the second scenario may indicate a name such as “LANE CHANGE.” Scenario symbol 432 corresponding to third scenario illustrates a section of highway indicating a highway merge scenario. Button icon 406-3 for the third scenario may include a “3” symbol or other symbol matching a symbol on the corresponding button of the buttons (e.g., 328) of the wheel device (e.g., 308, each shown in FIG. 3). Name icon 408-3 for the third scenario may indicate a (e.g., abbreviated) name such as “HWY MERGE.” Scenario symbol 434 corresponding to the fourth scenario illustrates an intersection of a road section of highway indicating an intersection scenario. Button icon 406-4 for the fourth scenario may include a “4” symbol or other symbol matching a symbol on the corresponding button of the buttons (e.g., 328) of the wheel device (e.g., 308, each shown in FIG. 3). Name icon 408-4 for the fourth scenario may indicate a name such as “INTERSECTION.” These scenario symbols 428 to 434 are merely examples, and are not limiting. For example, in an embodiment of demo application that focuses on the response of the autonomous vehicle to emergency vehicles, symbols 428 to 434 may show an ambulance, a fire truck, and the like.

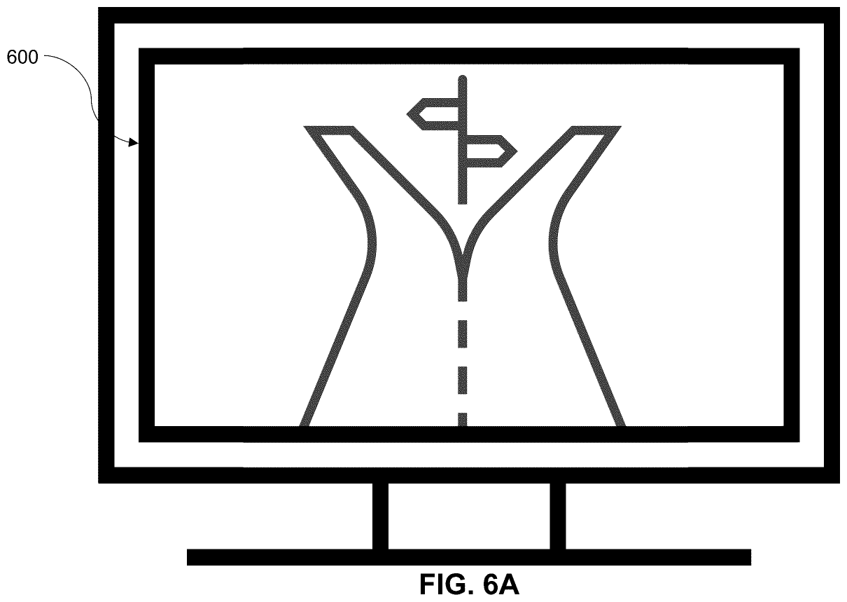

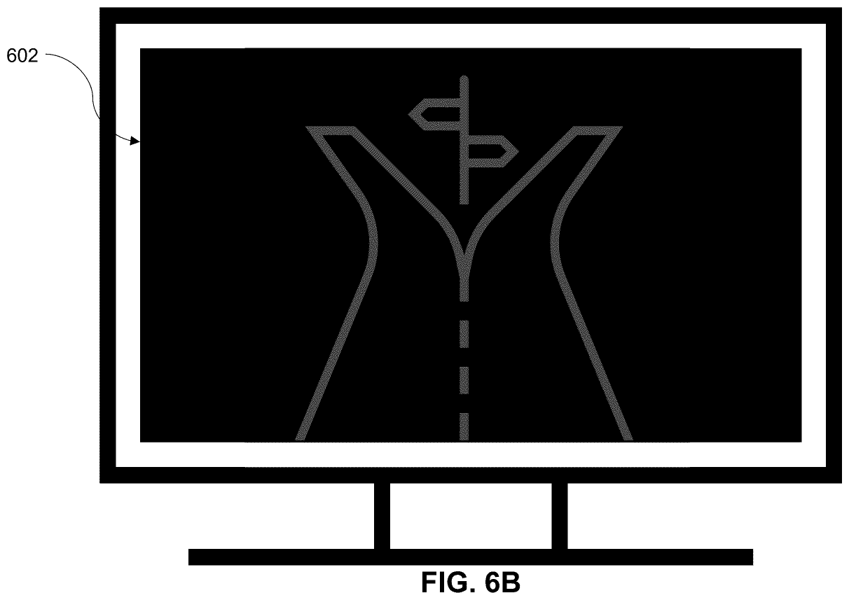

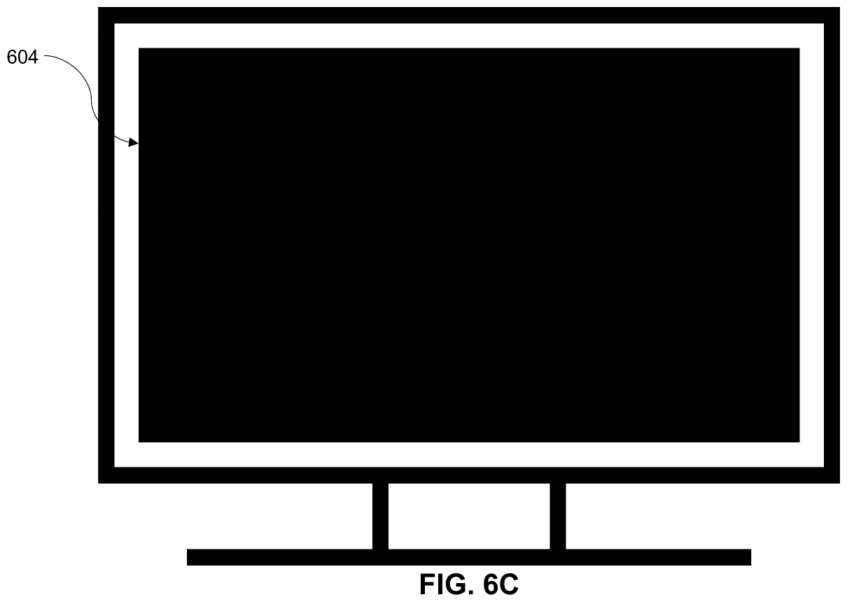

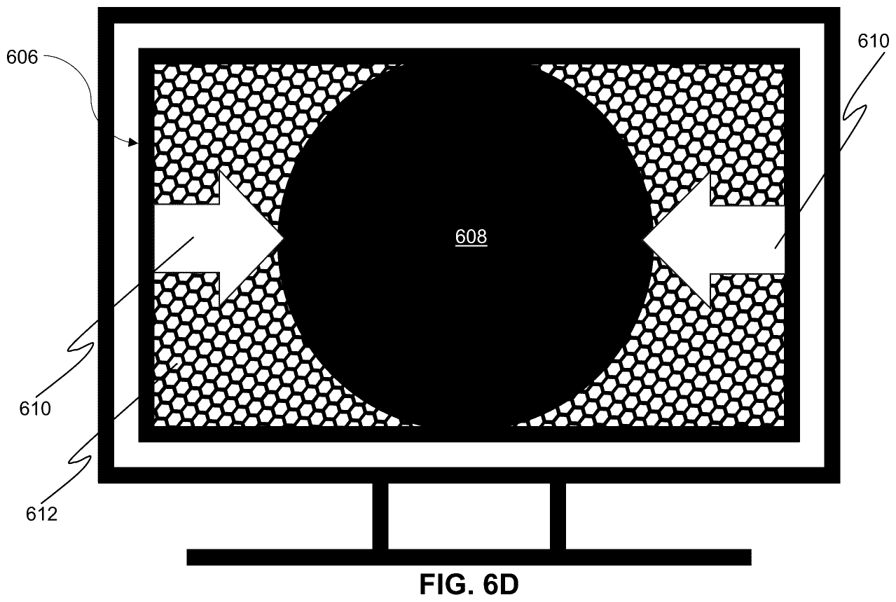

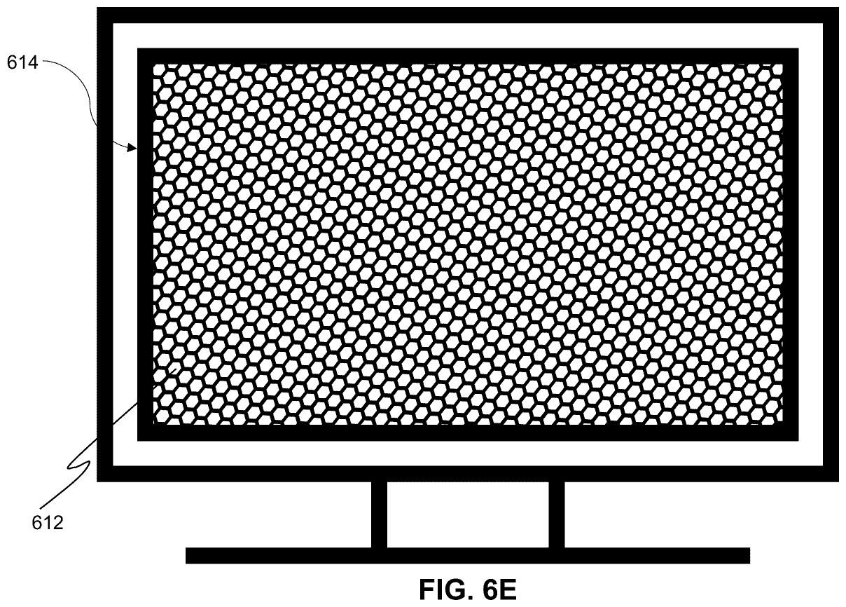

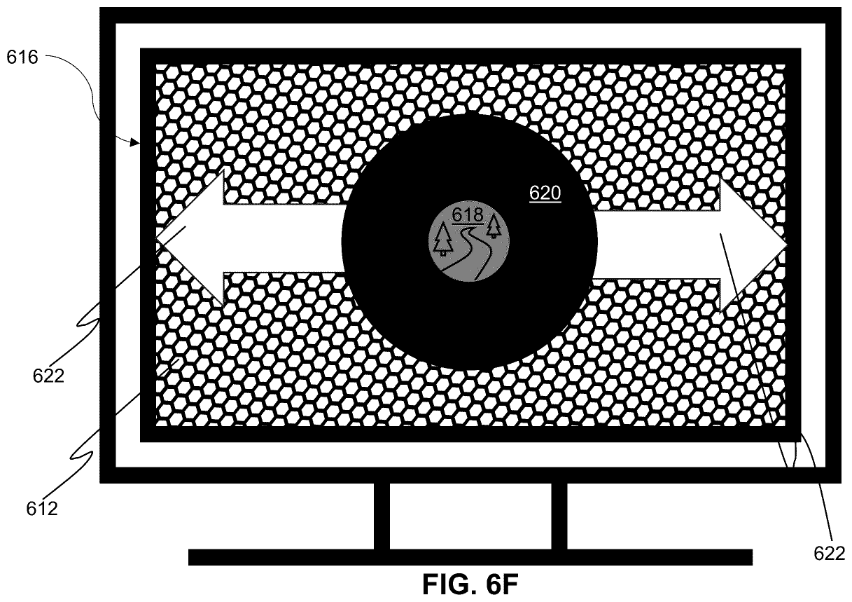

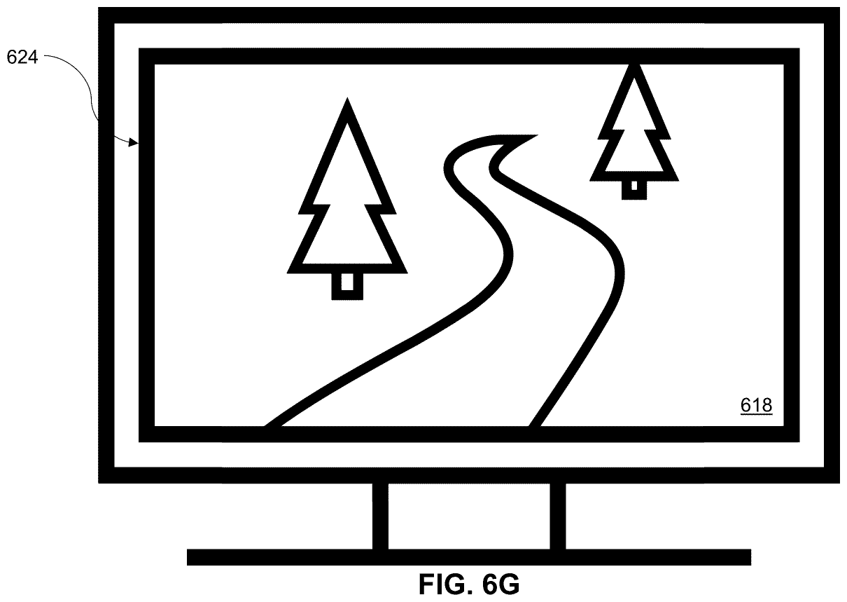

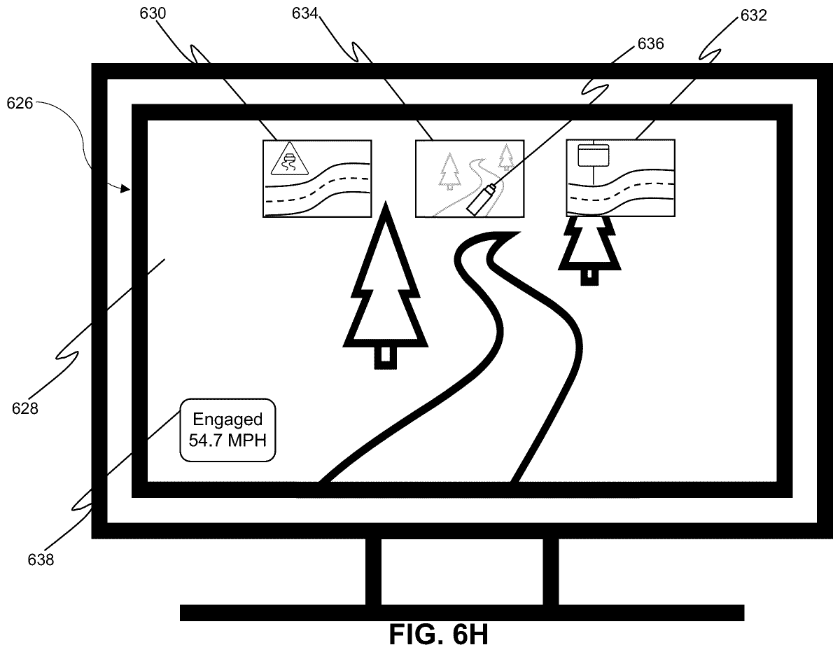

Upon selection of a scenario (e.g., via selecting a button of buttons 328 of wheel device 308 matching the desired scenario (e.g., icons 404-1 to 404-4)), a transition/loading screen sequence may trigger (described below in connection with FIGS. 6A-6H, described later). The transition/loading screen sequence may be configured as an overlay to the base video file, and have a duration sufficient to allow the selected scenario to load. The scenarios shown in FIG. 4B are just a few examples of scenarios, and the scenarios may be rotated and/or updated periodically, or set to be specifically tailored to show particular aspects based on the type of even the demo is provided at. For example, at a fire/police trade show, the scenarios may focus on videos that show a response of the autonomous vehicle to a passing emergency vehicle.

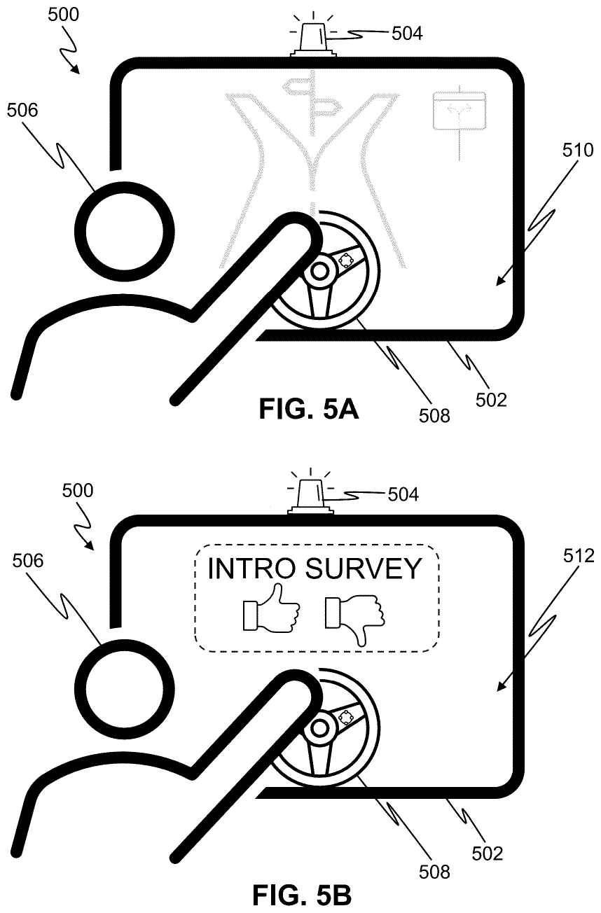

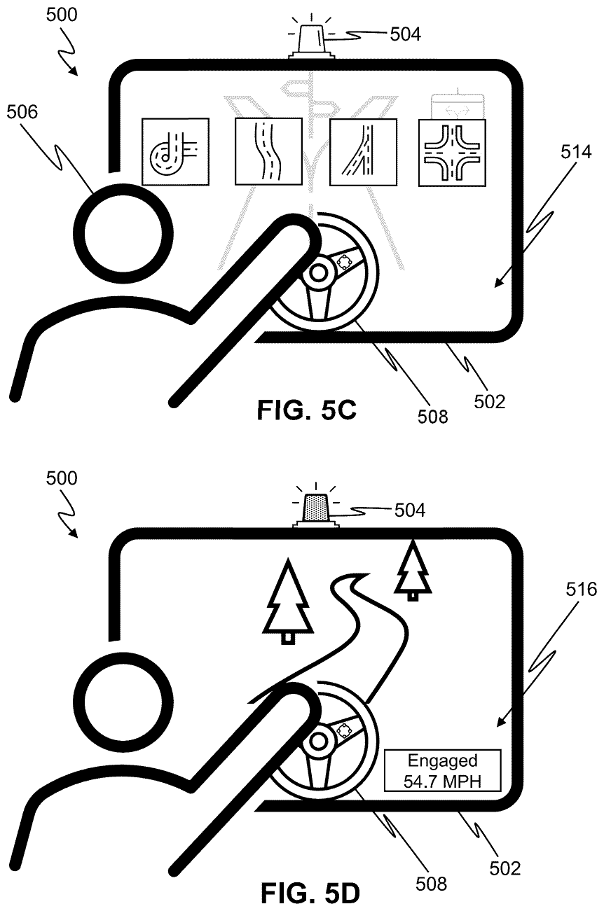

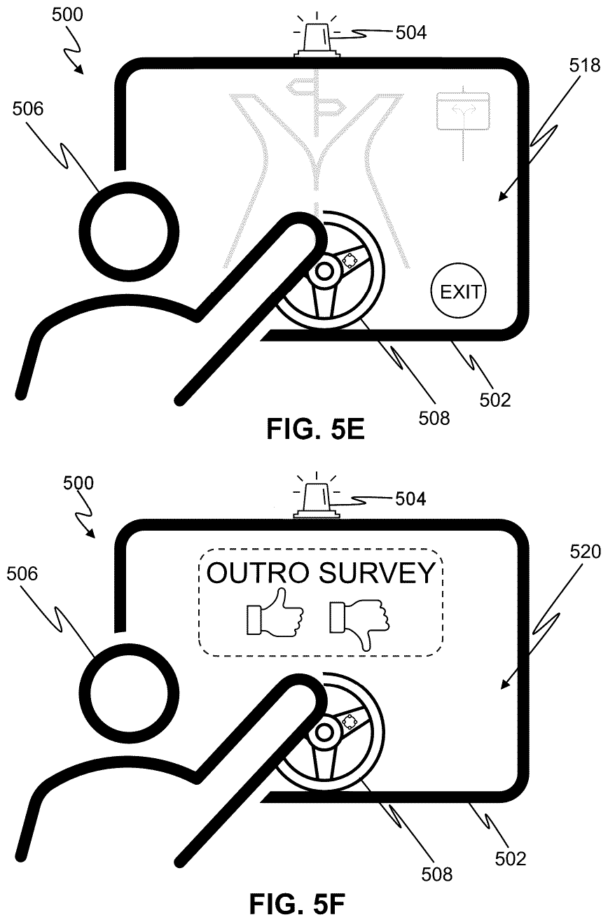

FIGS. 5A to 5E illustrate an example demo experience by a user. In FIGS. 5A-5E, VAV demonstration system 500 is a demo system that is the same as or similar to VAV demonstration system 300 shown in FIG. 3, and includes a display device 502 (the same as or similar to display device 302 shown in FIG. 3) and a status light 504 (the same as or similar to status light 314 and 422 shown in FIGS. 3 and 4, respectively). Display device 502 displays the video (e.g., 316) of the demo application (e.g., 330) as output by the control device (not shown, but the same as or similar to control device 304 shown in FIG. 3). User 506 (e.g., the same as or similar to user 316 shown in FIG. 3) sits in a seat (e.g., 310) of VAV demonstration system 500 and uses wheel device 508 (e.g., the same as or similar to wheel device 308 shown in FIG. 3) to participate in the demo. In FIG. 5A, user 506 experiences a start screen 510 in which wheel device 508 may move to simulate movement of the autonomous vehicle 100, such as a driving scene when the vehicle is driving on the highway. In FIG. 5B, the user 506 may start the demo (e.g., by pressing directional pad 326 or a button (e.g., the same as or similar to buttons 328 shown in FIG. 3) of the wheel device 508 and be presented with an introductory survey screen 512 asking user 506 to provide their opinion on various topics relating to autonomous driving technology. The introductory survey may ask a user about their impressions, opinions, and/or knowledge level regarding autonomous driving and/or related topics. The survey answers may be collected and analyzed to determine user sentiment regarding autonomous driving technology, and used for business purposes (e.g., marketing). After completion of the introductory survey, in FIG. 5C, user 506 is presented with a scenario selection screen 514 that presents selectable scenarios (e.g., the same as or similar to those associated with icons 404-1 to 404-4 shown in FIG. 4A). After selection of the desired scenario, in FIG. 5D, user 506 is presented with a screen 516 of the selected scenario, which plays the video associated with the selected scenario, and moves the wheel as described herein. For example, the selected scenario may be a highway drive scenario such as indicated by name icon 408-1 and symbol 428, each shown in FIG. 4B. Scenario screen 516 may include various indicia such as speed indicia and/or driving state indicia (similar to driving state indicator 416 and speed indicator 418 in FIG. 4A), and status light 504 may illuminate in a color indicating a driving state of the autonomous vehicle shown in the video, such as a color (e.g., the same as or similar to color 424 shown in FIG. 4A) indicating an autonomous driving state, for example. In FIG. 5E, user 506 may be presented with an exit screen 518, including an EXIT button the same as or similar to EXIT button 420 shown in FIG. 4A. In FIG. 5F, after existing the scenario and/or the scenario selection screen, an exit (e.g., outro) survey screen 520 may appear, asking user 506 to again provide their opinion on various topics relating to autonomous driving technology. Answers to the outro survey may be collected and analyzed to determine if the demo experience changed the user's impressions of autonomous technology, and used for business purposes. Comparing FIGS. 5D and 5E, status light 514 reverts to a standard illumination status (which may be non-illuminated) in FIG. 5E. Screens 512 and 520 may appear in a different order than depicted in the series of screens shown in FIGS. 5A to 5F. Additional screens, not shown, may also be included as part of the demo experience. For example, after the outro survey screen 520, an additional screen may be presented including social media account information of the company displaying the demo, or other contact information/details. VAV demonstration system 500 may have physical signage nearby that provides a legend to users as to which buttons (e.g., 328) of wheel device 508 to press to control the demo (e.g., to select icons 404-1 to 404-4, etc.), including navigation within selectable options of the demo via directional pad (e.g., 326) of wheel device 508 (likewise for other demo systems described herein such as VAV demonstration system 300).

FIGS. 6A to 6H illustrate an example embodiment of a screen transition sequence and transition effect(s) utilized as part of the video playback aspects within the demo application. For example, the transition sequence shown in FIGS. 6A to 6H may take place in between screens 514 and 516 shown in FIGS. 5C and 5D, respectively, although this is not limiting and the transition sequence may appear between other screen changes of the demo (e.g., between any two videos as described herein). FIG. 6A illustrates a selection screen ending screen 600, representing the state just after when a user selects a scenario (e.g., FIG. 5C) from the introductory screen (e.g., 400 shown in FIG. 4) and the icons (e.g., 404-1 to 404-4) and other graphics (e.g., 410, 412) fade away graphically, leaving only the background image. FIG. 6B illustrates fade-in blackout screen 602, where the background image shown in FIG. 6A fades out and a black transition screen fades in. FIG. 6C illustrates blackout screen 604 where the background image shown in FIG. 6B has completely faded out and the screen is solid black (colors other than black may be used). FIG. 6D illustrates fade-out transition screen 606 where the black screen shown in FIG. 6C is replaced via a fade-in transition effect 608. The transition effect 608 may be a circle wipe visual effect, but this is an example transition effect and not limiting. Arrows 610 are not part of the visual graphics of the screen transition, and merely indicate the direction of motion of the transition effect 608. For example, as the fade-in transition progresses according to transition effect 608 and in a first direction corresponding to the motion of arrows 610, pattern 612 gradually replaces the black screen shown in FIG. 6C. Pattern 612 may start at the edges of the screen of the display device in a circular manner and gradually close at the center of the screen, where pattern 612 may be a pattern consistent with the branding 410/412 shown in FIG. 4A or other pattern. Pattern 612 in FIG. 6D is a hexagon pattern, for example. FIG. 6E illustrates pattern screen 614, a point in the transition sequence where pattern 612 has completed filled the screen of the display device. FIG. 6F illustrates a fade-out screen 616 where the pattern 612 fades out as it is replaced by the selected scenario video 618, which loads and fades in via fade-in transition effect 620. Fade-in transition effect 620 may be the same type of effect as that of fade-out transition effect 608, but in reverse motion (e.g., moves in a second direction opposite the first direction of arrows 610). For example, transition effect 620 may be a circle wipe visual effect, but this is an example transition effect and not limiting. The size of selected scenario video 618 may grow in size according to transition effect 620 as shown by arrows 622. Arrows 622 are not part of the transition animation, and only appear in FIG. 6F to show the direction in which transition effect 620 moves (e.g., outward from the center of the screen of the display device). FIG. 6G illustrates an initial scenario video screen 624 where selected scenario video 618 shown in FIG. 6F has filled the entire screen of the display device (e.g., transition effect 620 has completed and the video has loaded). FIG. 6H illustrates a final scenario video screen 626 that illustrates additional aspects of a loaded scenario video in accordance with some embodiments. For example, overlaid on a primary scenario video 628 may be additional secondary videos, including sideview mirror videos, and a LiDAR depiction video of the environment perceived by the autonomous vehicle 100. A left sideview mirror video may be displayed in a left secondary video overlay 630. The left sideview mirror video may have been captured during a real-world driving session of the autonomous vehicle by a camera (e.g., 214) located in the left sideview mirror (e.g., 104) of the autonomous vehicle 100. Similarly, right sideview mirror video captured by a right sideview mirror of autonomous vehicle 100 may be displayed in a right secondary video overlay 632. A middle secondary video overlay 634 may display a LiDAR representation of the environment perceived by LiDAR sensors of the autonomous vehicle during the driving session. The LiDAR representation may show a facsimile 636 of the autonomous vehicle overlaid on a highway or road along with LiDAR perceived environmental objects such as trees, road signs, and the like. Each of the primary video, left sideview mirror video, right sideview mirror video, and LiDAR representation video are synchronized with primary scenario video 628 to show a plurality of views as recorded/perceived by the autonomous vehicle sensing equipment (e.g., 202) during the real-world driving session. An information panel 638 may also be overlaid on primary scenario video 628, and show information such as a speed of the autonomous vehicle in the video and the driving state (e.g., autonomous driving engaged) of the autonomous vehicle (similar to driving state indicator 416 and speed indicator 418 shown in FIG. 4A). While not shown, a status light such as status light 314/422/504 may be used with the display device shown in FIGS. 6A to 6H to indicate the driving state of the autonomous vehicle in the selected scenario video as described herein. For example, in correspondence with information panel 638, a status light may illuminate in a color matching the driving state (e.g., autonomous or manual) of the vehicle in the video, as described herein.

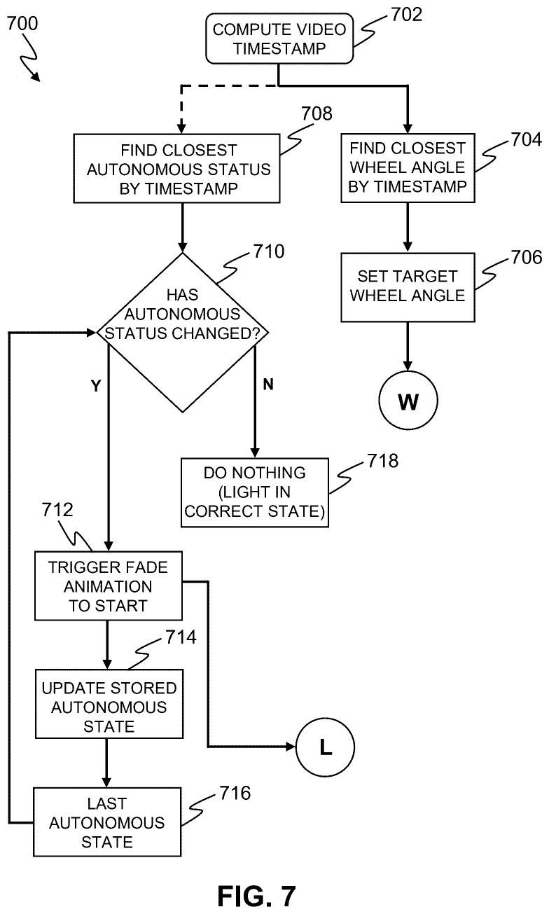

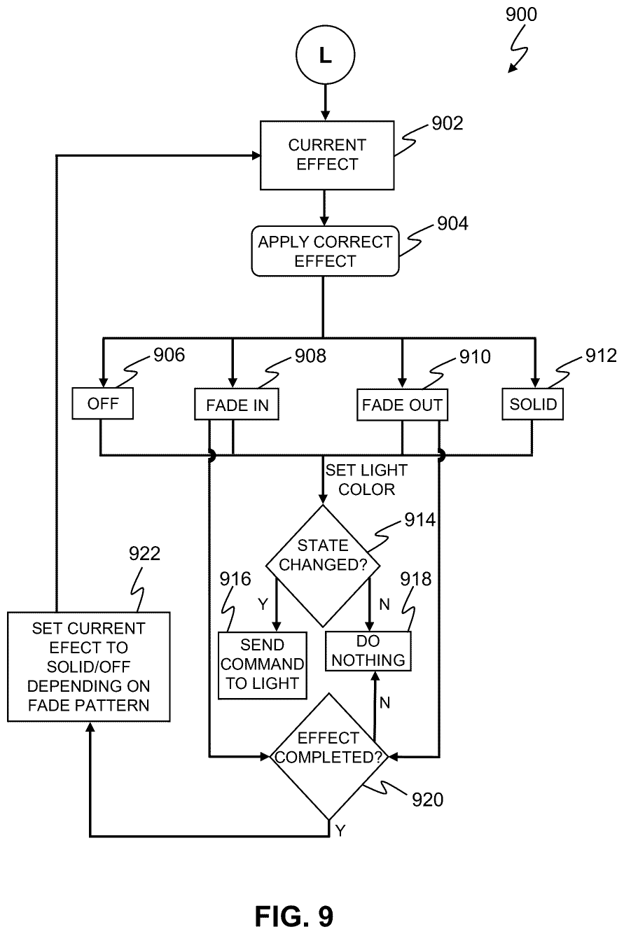

FIG. 7 illustrates an example main control program 700 flow chart according to one embodiment of the present disclosure. This main control program may run on a fixed duration time clock generated a (e.g., GUI) library. A timestamp of the video is computed 702 as described herein (e.g., current progress into the video is read and the timestamp of the video is calculated). A closest wheel angle according to timestamp is determined 704 from the wheel data (e.g., a search through the map for the closest timestamp to the video frame timestamp is performed and the angle value for that time is retrieved). This angle value is then set 706 as the target angle for the wheel, and a calculation is performed to determine what force if any should be sent to the wheel for this iteration of the loop. An output of the set target wheel angle may be sent to a wheel control program W (e.g., see wheel control program 800 shown in FIG. 8). An optional function of the program includes finding 708 a closest autonomous status timestamp (e.g., optional based on the configuration), determining 710 if the autonomous status has changed. If yes (Y) at determining 710, the program proceeds to trigger 712 the transition screen(s) shown in FIGS. 6B to 6F to run (e.g., a software flag or other indicator representing trigger 712 may be output to a status light control program (e.g., see status light control program 900 in FIG. 9)). The stored autonomous state is updated 714. The last autonomous state is set 716, which may feedback to determining 710 in a loop. If no (N) at determining 710, no additional steps are performed as the status light is in the correct state.

FIG. 8 illustrates an example wheel control program 800 flow chart according to one embodiment of the present disclosure (and may be a configuration of the custom position controller described herein). A target wheel angle 802 (e.g., the target wheel angle as set at 706 in FIG. 7) is utilized in connection with a read 804 of the wheel angle, to determine (compute) 806 a difference between the read and target wheel angle(s). The wheel force control is performed in two phases depending on how far the current actual angle is from the target angle. Then a determination regarding brake range is made. If the difference between the current angle value and the target angle is a relatively small value at or under a configurable threshold, a braking routine is performed and used to calculate 808 the braking torque value. This braking torque value uses a calculation to determine the correct direction and force to apply to keep the wheel centered at its current point. This torque value is set proportionally to the difference to smoothly stop the wheel at a desired location without introducing oscillations that break the immersion of the user. This braking torque value thus acts to smoothly stop the wheel at the desired position, but also works to counteract a force applied by the user if they are resting their hands on the wheel during the demo. The torque value used can be up to our max safe torque limit, but only within the small range of braking position, so that the user can still force the wheel to a different angle if they desire, which engages the rotation calculation routine. If the target position is achieved within a tolerance, the commanded torque is set to 0 to hold the wheel in place. More specifically, if the difference is greater than the threshold, a proportional torque is applied 810 relative to the difference such that it fades toward zero when approaching a desired location. If the difference is less than a threshold, zero torque value is applied 812 to hold the wheel in the current position. If not within brake range, a rotation torque is calculated 814. If the difference is less than a low speed threshold, a low speed torque is applied 816 in the desired direction. If the difference is greater than a low speed threshold, a high speed torque value is applied 818 in the desired direction. More specifically, and for example, if the target position is outside of the small braking torque tolerance, a switch is made to using a rotation calculation routine (e.g., 814) which can operate in either low speed or high-speed torque modes depending on the magnitude of the difference between the current and target positions. If the magnitude is under a configurable high-speed threshold, a low-speed torque value is used (e.g., 816), which is set to move the wheel at a mild safe pace towards the braking region. The routine applies the constant low speed torque value to the wheel for the current cycle. This smooths the transition from the rotation route to the braking routine and acts to decelerate the wheel from the high-speed torque. If the wheel position is greater than the high-speed threshold, the high-speed torque value is used (e.g., 818) to quickly drive the wheel towards the desired position.

Together, the torque control drives the wheel quickly to any desired position from any starting position but does not overshoot and instead stops precisely and smoothly at the target position. Additionally, if the user places their hands on the wheel it will have enough torque to continue smooth operation and following of the bag recorded wheel. Furthermore, if the user decides to try and force the wheel to a different position, the wheel will initially start with a smaller corrective force, and as the magnitude of the difference increases past the high speed threshold, the force will increase up to the safe limit set by the software which is not configurable at runtime.

FIG. 9 illustrates an example status light control program 900 flow chart according to one embodiment of the present disclosure, and may be a configuration of the custom status light control scheme (e.g., the light controller). As described herein, the demo application is configured to interface with a status light to visually indicate via lighting effects the status (e.g., autonomous or manual) of the autonomous vehicle. These effects are implemented in an event loop run in a separate thread by the UI framework, so that the status light effects remain in sync with the rest of the application but are not impacted by the processing done in other parts of the system. Each of the effects uses variables shared across iterations to compute the color and/or brightness that is necessary to implement the desired effect. Some effects implemented are fading in/out, a flashing pattern, a smooth multicolor transition, a solid color, and an off state. Based on the current effect 902 applied to the light, the main event loop applies (e.g., runs) 904 the correct effect function responsible for implementing the effect logic. For example, the effects may be an OFF state 906, a fade-in effect 908, a fade-out effect 910, and a solid state (e.g., solid color) 912. As described herein, the OFF state 906 may be used when the demo is in the idle state such as shown in FIG. 4A or when there is no need to convey additional information to a user via the status light. The fade-in effect 908 may be utilized in conjunction with the fade-in screen shown in FIG. 6F. The fade-out effect 910 may be utilized in conjunction with the fade-out screen shown in FIG. 6D. The solid effect 912 may be used when a scenario video is playing, such as one solid color (e.g., 424 shown in FIG. 4A) when an autonomous driving state is engaged, and a different solid color (e.g., 426 shown in FIG. 4A) when a manual mode is engaged. Within program 900 a loop may run in connection with determining a state change 914. If yes (Y) at state change 914, a command is sent to the status light. If no (N) at state change 914, no other step is performed at no state change has been detected. With respect to the application of the fade-in effect 908 or fade-out effect 910, a loop may run in connection with if the effect has completed 920. If yes (Y), the light is either turned solid or turned off 922 depending on the fade effect (e.g., solid if fade-in, as the scenario video will be starting, and off of fade-out, since no scenario has loaded yet). If no (N), no other step is performed as the effect has not completed. These effects are intended to be set by various events in the main control program (e.g., 700) of the application and then run without feedback in the background via an asynchronous signaling mechanism. Decoupling the status light control program 900 makes the application more modular and allows the light to be enabled and disabled entirely in a straightforward manner.

The application uses the aforementioned status light control to display the autonomous state of the vehicle (e.g., if the vehicle is being driven by the autonomous software or is being manually driven by the safety driver) in sync with the video and wheel movements described herein. The application displays a solid configurable color when in autonomous mode and turns completely off (or in another different color) when in manual. Between these two states a smooth fade may be performed which makes the state transition less jarring for the viewer. The light may also fade to an off state when transitioning between any two videos (such as an idle video and a scenario video) and may only turn back on after the transition (see FIGS. 6A-6G) has completed and if the new video shows the autonomous vehicle in an autonomous state. The default state of OFF is also used in situations where no autonomous state data is available.

A configuration such as a JSON configuration may be utilized in conjunction with video files and bag files (e.g., Rosbag files) to package the necessary data files together in a streamlined package for execution in the demo. This enables the video file and other data files (e.g., wheel data, status light data) to be kept in their native format and improves the ability to make adjustments in the field (e.g., at a trade show) as needed, where such adjustments may include tweaking an offset factor synchronize the video being displayed with the wheel movement. This also enhances in-field usage of the demo system at events such as trade shows which may not have stable internet connections, as the software package can be run on a standard computer without the need for internet access. For example, regarding the status light control, in a similar manner to how the steering angle data is loaded, the autonomous status of the vehicle is loaded out of the Rosbag and indexed based on timestamp. Then in the main control program 700 of the application, the same video timestamp used for steering angle calculation is used to search for the appropriate autonomous state value. This value is then used to determine if the light should be illuminated or not, which signals if the vehicle is operating in autonomous or manual at that time in the video.

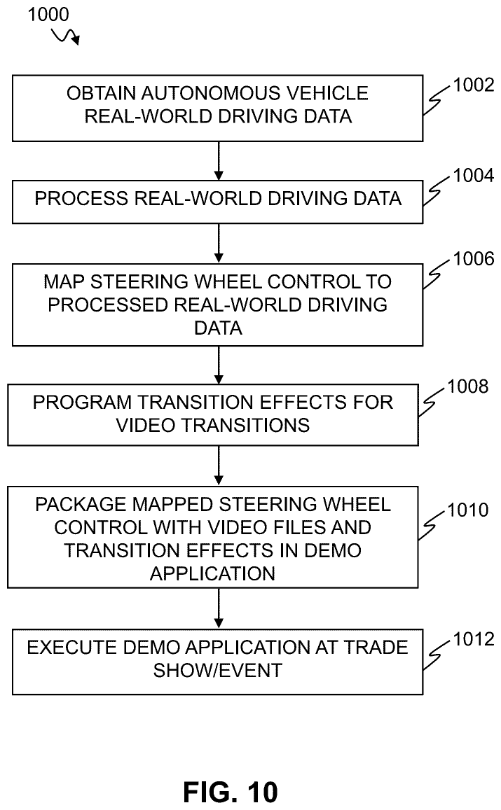

FIG. 10 illustrates an example method 1000 according to one embodiment of the present disclosure. Method 1000 includes obtaining 1002 autonomous vehicle real-world driving data, including video data and sensor data as described herein. Method 1000 includes processing 1004 the real-world driving data, for example to determine timestamps used for synchronizing steering wheel movement of the real-world driving data with movement in the video data and for mapping such movement to a steering wheel accessory as described herein. Method 1000 includes mapping 1006 steering wheel control to the processed real-world driving data, including synchronizing timestamps and controlling force and torque as described herein. Method 1000 includes programming 1008 transition effects and light effects for transitions between videos and scenarios as described herein, such as shown and described in connection with FIGS. 6A-6G. Method 1000 includes packaging 1010 the mapped steering control with video files prepared from the video data and the transition effects and light effects in a demo application. Method 1000 includes executing 1012 the demo application at a trade show or other event as described herein.

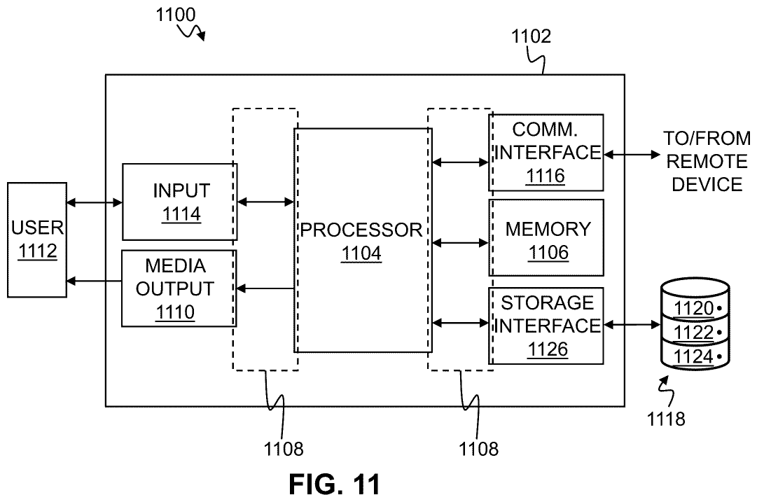

FIG. 11 is a block diagram showing an example configuration 1100 of a computing device 1102, which may be a configuration of control device 304 shown in FIG. 3, according to one embodiment of the present disclosure. The remote device referenced in FIG. 11 may include a display device such as display device 302, wheel device 308, and status light 314, each shown in FIG. 3. Computing device 1102 includes a processor 1104 and a memory device 1106. The processor 1104 is coupled to the memory device 1106 via a system bus 1108.

In some aspects, executable instructions may be stored in a memory area of memory 1106. Processor 1104 may include one or more processing units (e.g., in a multi-core configuration). Memory 1106 may be any device allowing information such as executable instructions and/or other data to be stored and retrieved. Memory 1106 may include one or more computer-readable media (e.g., hard drive, RAM, ROM, and the like).

Computing device 1102 may also include at least one media output component 1110 for presenting information to a user 1112 (e.g., the same as or similar to user 312 shown in FIG. 3 in the context of a user using the demo, and/or the same as operator 306 in the context of the person in charge of running the demo (e.g., an employee of the company that provides the demo)). Media output component 1110 may be any component capable of conveying information to a user 1112. In some aspects, media output component 1110 may include an output adapter, such as a video adapter and/or an audio adapter. An output adapter may be operatively coupled to processor 1104 and operatively coupled to an output device such as a display device (e.g., a liquid crystal display (LCD), organic light emitting diode (OLED) display, cathode ray tube (CRT), or “electronic ink” display) or an audio output device (e.g., a speaker or headphones). In some aspects, media output component 1110 may be configured to present an interactive user interface (e.g., a web browser or client application) to user 1112.

In some aspects, computing device 1102 may include an input device 1114 for receiving input from user 1112. Input device 1114 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 1110 and input device 1114.

Computing device 1102 may also include a communication interface 1116, which may be communicatively coupled to a remote device. Communication interface 1116 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory 1106 are, for example, computer-readable/-executable instructions for providing a user interface to user 1112 via media output component 1110 and, optionally, receiving and processing input from input device 1114. A user interface may include, among other possibilities, a web browser and client application. Web browsers enable users 1112 to display and interact with media and other information typically embedded on a web page or a website from a web server. A client application allows users 1112 to interact with a server application associated with, for example, a vendor or business.

Processor 1104 may also be operatively coupled to a storage device 1118. Storage device 1118 may be any computer-operated hardware suitable for storing and/or retrieving data. In some aspects, storage device 1118 may be integrated in computing device 1102. For example, computing device 1102 may include one or more hard disk drives as storage device 1118. In other aspects, storage device 1118 may be external to computing device 1102. For example, storage device 1118 may include multiple storage units such as hard disks or solid state disks in a redundant array of inexpensive disks (RAID) configuration. Storage device 1118 may include a storage area network (SAN) and/or a network attached storage (NAS) system. Storage device 1118 may store demo application files 332 shown in FIG. 3, which may include video/video data files 1120, wheel data files 1122, status light files 1124, and all other files for purposes of creating and running the demo, including any programs, API's, or other code, including the map data structure of the VAV demonstration system as described herein.

In some aspects, processor 1104 may be operatively coupled to storage device 1118 via a storage interface 1126. Storage interface 1126 may be any component capable of providing processor 1104 with access to storage device 1118. Storage interface 1126 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 1104 with access to storage device 1118.

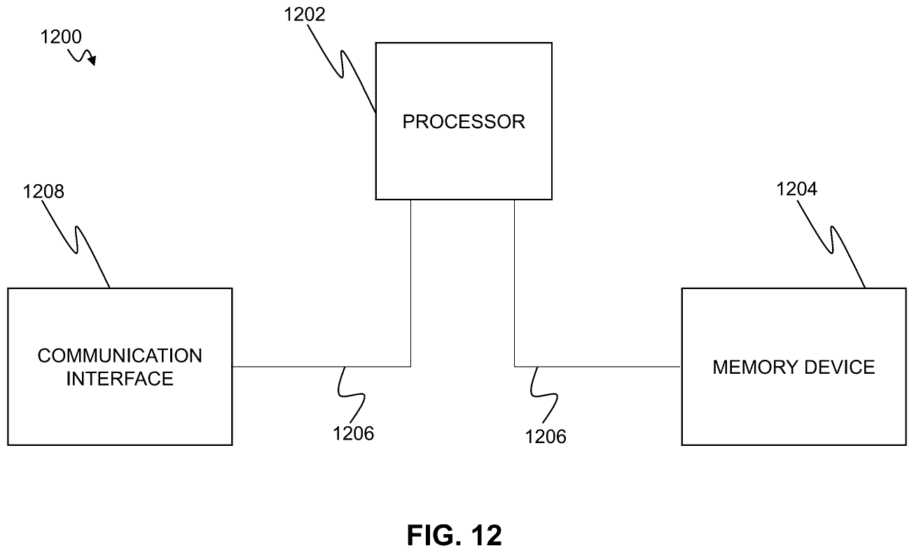

FIG. 12 is a block diagram of an example autonomy computing device 1200, which may be part of autonomy computing system 200 shown in FIG. 2. Autonomy computing device 1200 includes a processor 1202 and a memory device 1204. The processor 1202 is coupled to the memory device 1204 via a system bus 1208. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 1204 includes one or more devices that enable information, such as executable instructions or other data (e.g., sensor data), to be stored and retrieved. Moreover, the memory device 1204 includes one or more computer readable media, such as, without limitation, dynamic random access memory (DRAM), static random access memory (SRAM), a solid state disk, or a hard disk. In the example embodiment, the memory device 1204 stores, without limitation, application source code, application object code, configuration data, additional input events, application states, assertion statements, validation results, or any other type of data. The autonomy computing device 1200, in the example embodiment, may also include a communication interface 1206 that is coupled to the processor 1202 via system bus 1208. Moreover, the communication interface 1206 is communicatively coupled to data acquisition devices.

In the example embodiment, processor 1202 may be programmed by encoding an operation using one or more executable instructions and providing the executable instructions in the memory device 1204. In the example embodiment, the processor 1202 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

Some of the technical problems addressed by the present disclosure include: (a) making a commercially (e.g., off-the-shelf) wheel device mimic real-world wheel data from an autonomous vehicle; (b) avoiding jerky motion of the wheel device during such mimicking (for example, steering wheel devices used with racing-style video games are normally configured to resist a player to simulate the resistance a driver would face while racing); (c) seamless transition between video playback; and (d) integrated visual cues using a combination of display elements, including a status light.

An example technical effect of the methods, systems, and apparatus described herein includes at least one of: (a) mapping real-world autonomous vehicle data to a commercially-available steering wheel accessory to replicate the experience of an autonomous vehicle to a user; (b) creating a streamlined file package for containing real-world video data and real-world driving data for improved ability to maintain synchronization between a video being displayed and a corresponding movement of a commercially-available steering wheel accessory that has been programmed to match the movement shown in the video; (c) ability to select different video scenarios on the fly without the need for program/code changes; (d) augmenting the standard control code of commercially-available wheel accessories with custom code (e.g., API's) to cause the wheel accessory to move in the desired manner (e.g., counter to the wheel accessory's standard movement); (e) providing seamless GUI transitions and other graphical overlays to enhance a user experience; and (f) providing multiple visual cues via GUI indicia and external lighting sources to a demo user to inform the user as to the status of vehicle states within the demo.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A virtual autonomous vehicle (VAV) demonstration system comprising:
a display device configured to display a VAV demonstration application, wherein the VAV demonstration application includes video data and steering wheel data obtained from a real-world driving session of an autonomous vehicle;
a steering wheel; and
a control device coupled with the steering wheel and the display device, the control device comprising at least one processor in communication with at least one memory device, the at least one processor programmed to:
control, via a video control scheme, playback of the video data; and
control, via a steering wheel control scheme, movement of the steering wheel (i) based on the steering wheel data and (ii) in correspondence with motion of the autonomous vehicle in the video data.

2. The VAV demonstration system of claim 1, wherein the steering wheel data comprises steering wheel angle data obtained from motion of a steering wheel of the autonomous vehicle during the driving session.

3. The VAV demonstration system of claim 1, wherein the steering wheel angle data is mapped and stored in a map data structure of the VAV demonstration application.

4. The VAV demonstration system of claim 1, wherein the at least one processor is further programmed to:
determine a video timestamp of a progress in the video data.

5. The VAV demonstration system of 4, wherein the at least one processor is further programmed to:
determine a target wheel angle value in the steering wheel data as an angle value at a wheel angle timestamp corresponding to the video timestamp.

6. The VAV demonstration system of claim 5, wherein the at least one processor is further programmed to:
calculate an amount of force to be applied to the steering wheel based on the target wheel angle value and a current wheel angle value of the steering wheel.

7. The VAV demonstration system of claim 6, wherein the at least one processor is further programmed to:
calculate the force by:
executing a braking routine when a difference between the target wheel angle value and the current angle value is at or below a threshold.

8. The VAV demonstration system of claim 6, wherein the at least one processor is further programmed to:
calculate the force by:
executing a rotation calculation routine when a difference between the target wheel angle value and current wheel angle value is above a threshold.

9. The VAV demonstration system of claim 1, wherein the video data includes an idle video and one or more selectable scenario videos, and when a scenario video of the one or more selectable scenario videos is selected by a user via a control input of the steering wheel, the at least one processor is further programmed to:
display a transition effect as part of the transition between the idle video and the selected scenario video.

10. The VAV demonstration system of claim 9, wherein the at least one processor is further programmed to:
display the transition effect in a first direction and then in a second direction opposite the first direction.

11. The VAV demonstration system of claim 9, wherein the least one processor is further programmed to:
overlay the transition effect over the idle video while the selected scenario video is being loaded.

12. The VAV demonstration system of claim 9, further comprising a status light, wherein the at least one processor is further programmed to:
synchronize an illumination of the status light with a driving state of the autonomous vehicle in at least one of the one or more selectable scenario videos.

13. The VAV demonstration system of claim 12, wherein the driving state of the autonomous vehicle includes an autonomous driving state and a manual driving state, and the at least one processor is further programmed to:
control the illumination of the status light in a first color corresponding to the autonomous driving state and a second color corresponding to the manual driving state, the second color being different than the first color.

14. The VAV demonstration system of claim 1, wherein the at least one processor is further programmed to:
present, as part of the video control scheme, one or more user surveys on the display device.

15. A method for a virtual autonomous vehicle (VAV) demonstration comprising:
configuring a display device to display a VAV demonstration application, wherein the VAV demonstration application includes video data and steering wheel data obtained from a real-world driving session of an autonomous vehicle;
providing a steering wheel;
coupling a control device with the steering wheel and the display device;
controlling, via a video control scheme, playback of the video data; and
controlling, via a steering wheel control scheme, movement of the steering wheel (i) based on the steering wheel data and (ii) in correspondence with motion of the autonomous vehicle in the video data.

16. The method of claim 15, further comprising controlling a status light associated with the display device and the steering wheel to synchronize an illumination of the status light with a driving state of the autonomous vehicle the video.

17. The method of claim 15, wherein the steering wheel data includes steering wheel angle data obtained from motion of a steering wheel of the autonomous vehicle during the driving session.

18. One or more non-transitory computer-readable storage media for a virtual autonomous vehicle (VAV) demonstration, the one or more non-transitory computer-readable storage media comprising a plurality of instructions stored thereon that, in response to being executed, cause a VAV demonstration system to:
display a VAV demonstration application on a display device of the VAV demonstration system, wherein the VAV demonstration application includes video data and steering wheel data obtained from a real-world driving session of an autonomous vehicle;
control, via a video control scheme, playback of the video data; and
control, via a steering wheel control scheme, movement of the steering wheel (i) based on the steering wheel data and (ii) in correspondence with motion of the autonomous vehicle in the video data.

19. The one or more non-transitory computer-readable storage media of claim 18, wherein the video data includes an idle video and one or more selectable scenario videos, and when a scenario video of the one or more selectable scenario videos is selected by a user via a control input of the steering wheel, a transition effect is displayed as part of the transition between the idle video and the selected scenario video.

20. The one or more non-transitory computer-readable storage media of claim 18, wherein the plurality of instructions further cause the VAV demonstration system to:
determine a video timestamp of a progress in the video data;
determine a target wheel angle value in the steering wheel data as an angle value at a wheel angle timestamp corresponding to the video timestamp; and
calculate an amount of force to be applied to the steering wheel based on the target wheel angle value and a current wheel angle value of the steering wheel.
